(19) United States
(12) Patent Application Publication
(10) Pub. No.: US 2004/0013583 A1
(43) Pub. Date: Jan. 22, 2004

(54) Apparatus and method for a sanitizing air filter

(75) Inventor: Robert W. Burkhardt, Plano, TX (US)

Correspondence Address: HUGHES & LUCE LLP, 1717 MAIN STREET, SUITE 2800, DALLAS, TX, 75201, US

(73) Assignee: Aerus LLC, Dallas, TX

(21) Appl. No.: 10/199,254

(22) Filed: Jul. 19, 2002

(51) Int. Cl. B01J 19/08

(52) U.S. Cl. 422/186.3

(57) ABSTRACT

A system for sanitizing and filtering air includes a chamber through which air passes, the chamber containing an ultraviolet light source. A sanitizing filter is removably mounted in the chamber, the filter containing a mechanical filtration media and a photocatalytic agent. The ultraviolet light illuminates the photocatalytic agent, and air passing through the chamber is purified by the photocatalytic agent and filtered by the mechanical filtration media. The system may also ionize the air, thereby polarizing particles in the air. When the polarized particles are caught in the filter they polarize the filter media, causing it to electrostatically attract other polarized particles in the air, thereby improving its filtration efficiency.

### TECHNICAL FIELD OF THE INVENTION

The present invention relates to air cleaners and more specifically to an air cleaner sanitizing the air through use of a photocatalyst.

### BACKGROUND OF THE INVENTION

Indoor air quality has a tremendous impact on human health. The three major strategies for improving the quality of indoor air are controlling the sources of indoor pollution to reduce their production, diluting pollutants in indoor air with outside air through ventilation, and removing pollutants from indoor air using an air cleaner.

Air cleaners work to remove both particulate and gaseous pollutants. Particulate pollutants include, for example, inorganic and organic compounds, tobacco smoke, fungal spores, mold, pollens, and living organisms such as bacteria and viruses. Gaseous pollutants include, for example, carbon monoxide, nitrogen oxide, and other combustion byproducts, as well as volatile organic compounds (VOCs), aldehydes, ketones and other gasses given off by construction products, adhesives, paints and varnishes.

Particulate pollutants are generally removed with a mechanical filtration system, which employs a fibrous material or media through which polluted air is drawn. Particulate pollutants are trapped in the filter media and thereby removed from the air. Gaseous pollutants are generally too small to be trapped by mechanical filtration media. Living particulate pollutants may be removed from the air by mechanical filtration media, however they continue to live within the media. As a result they may be released back into the air when the filtration media is removed from the air cleaner.

Live particulate pollutants and some gaseous pollutants may be treated with ultraviolet (UV) radiation. This kills live pollutants by causing mutations in their DNA, thereby preventing reproduction of the organism. UV radiation also can break the electron bonds of organic pollutants, reducing them to harmless component molecules. However, high intensity UV light is required to achieve these effects, which is harmful to humans and animals and which can produce ozone as a byproduct.

Photocatalytic oxidation can be used to kill live pollutants, and to oxidize VOCs, carbon monoxide and other gaseous pollutants. When a photocatalyst, such as titanium dioxide (TiO₂) is irradiated with UV light it behaves as a catalyst, enabling the oxidation of the pollutants described above. However, the killed organisms and other oxidation byproducts can collect on the surface of the photocatalyst, leading to a reduction in its efficiency and a degradation in the performance of the air cleaner.

As such, many air cleaners suffer from deficiencies in removing both particulate and gaseous pollutants from indoor air without producing harmful byproducts and without a decrease in filtration efficiency over the lifetime of the air cleaner. Many other problems and disadvantages of the prior art will become apparent to one skilled in the art after comparing such prior art with the present invention as described herein.

### SUMMARY OF THE INVENTION

The present invention provides a sanitizing air cleaner that substantially eliminates or reduces disadvantages and problems associated with previously developed systems.

More specifically, aspects of the invention can be found in a system for sanitizing and filtering air that has a chamber through which air passes. An ultraviolet light source is mounted in the chamber and illuminates a sanitizing filter removably mounted in the chamber. The filter includes a mechanical filtration media and a photocatalyst. The ultraviolet light activates the photocatalyst and the air passing through the chamber is purified by the photocatalytic agent and filtered by the mechanical filtration media.

The system may include an ionization unit in the air passage that ionizes the air before it reaches the sanitizing filter, the ionized air polarizing the particulate pollutants in the air, and the polarized particles polarizing the surface of the mechanical filtration media when trapped therein. The ultraviolet light source may include means to evenly distribute the light across the photocatalyst.

Further aspects of the invention may be found in a sanitizing air filter, for use in an air passage having a source of ultraviolet light. The sanitizing filter includes a mechanical filtration media and a photocatalytic agent. The sanitizing air filter is removably mounted in the air passage such that the ultraviolet light illuminates the photocatalytic agent. The air passage may also have an ionization source that ionizes the air in the air passage, which polarizes the particles in the air, and the mechanical filtration media may be made of electrically non-conductive material, whereby polarized particles trapped in the media polarize the media, and other polarized particles are electrically attracted to the polarized media.

Further aspects of the invention may be found in a method of sanitizing and filtering air. The steps of the method include inserting a sanitizing air filter in a chamber through which air passes, the filter containing a mechanical filtration media and a photocatalytic agent, and illuminating the photocatalytic agent with ultraviolet light. The steps of the method also include renewing the photocatalytic agent by removing the sanitizing air filter and inserting a new sanitizing air filter, the air being sterilized by passing over the photocatalytic agent and filtered by passing through the mechanical filtration media. The mechanical filtration media may be electrically non-conductive and the steps of the method may further include creating ions in the air in the chamber which polarize the particles in the air. A further step of trapping the polarized particles in the mechanical filtration media causes the surface molecules of the media to become polarized, with the result that the polarized particles in the air are electrostatically attracted to the polarized media, improving its filtration efficiency.

### BRIEF DESCRIPTION OF THE DRAWINGS

For a more complete understanding of the present invention and advantages thereof, reference is now made to the following description taken in conjunction with the accompanying drawings in which like reference numbers indicate like features and wherein:

FIG. 1 shows an embodiment of the present invention in front, top and side views;

FIG. 2 is a cross-sectional view of a filter embodying the present invention;

FIG. 3 is an isometric view of a free-standing air cleaner embodiment of the present invention;

FIG. 4 is an isometric view of a duct mounted embodiment of the present invention;

FIG. 5 is a top view of a vacuum cleaner incorporating an air filter according to the present invention;

FIG. 6 is a view of the ultraviolet light in an embodiment of the present invention;

FIG. 7 is a view of a compound reflector used with the ultraviolet light in an embodiment of the present invention; and

FIG. 8 is a view of a compound lens used with the ultraviolet light in an embodiment of the present invention.

### DETAILED DESCRIPTION OF THE INVENTION

Exemplary embodiments of the invention are illustrated in the Figures, like numerals being used to refer to like and corresponding parts of the various Figures.

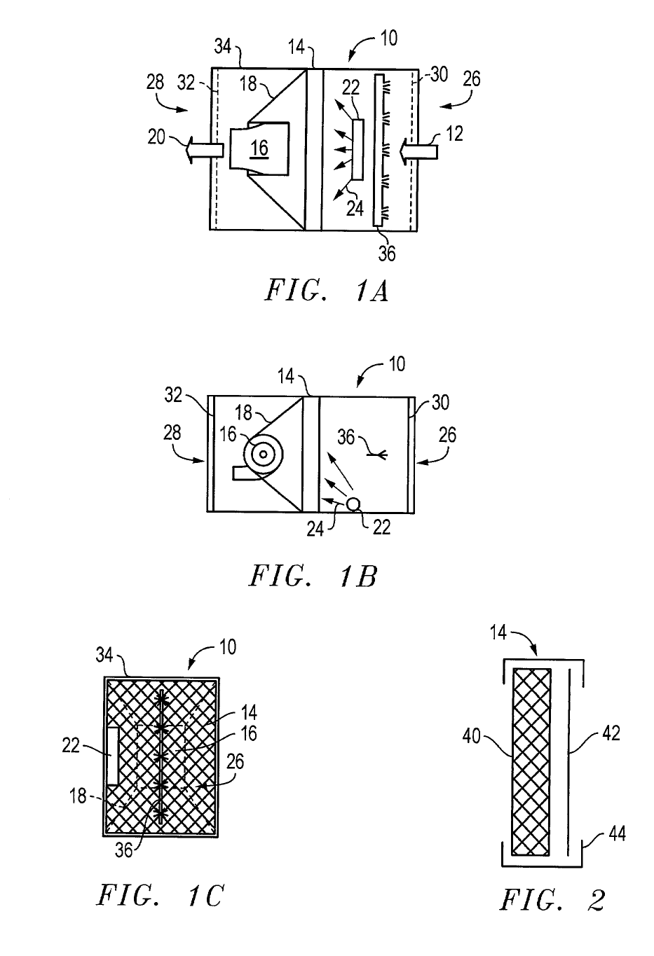

FIG. 1 shows three views of sanitizing air cleaner unit 10 embodying the present invention. FIG. 1A is a front view, FIG. 1B a top view and FIG. 1C a side view. Referring to FIG. 1A, air filter unit 10 is enclosed in high-quality galvanized steel housing 34, which has apertures 26 and 28 at opposite ends. Polluted air 12 enters housing 34 via inlet aperture 26, passing through grille 30, which also acts as a light baffle to prevent ultraviolet (UV) radiation 24 emitted by UV lamp 22 from escaping housing 34. The polluted air then passes over ion brushes 36, through sanitizing filter 14 and emerges through grille 32 in outlet aperture 28 as filtered, purified air 20. Fan 16, coupled to filter 14 by shroud 18, pulls the air into housing 34 and through filter 14. Ultraviolet lamp 22 illuminates filter 14 with UV radiation 24. Filter 14 has a layer coated with titanium dioxide (TiO₂) that is activated by UV radiation 24.

FIG. 1B shows a top view of air cleaner unit 10. Ultraviolet lamp 22, mounted on one side of housing 34 in this embodiment of the invention, illuminates sanitizing filter 14 with UV radiation 24. Fan 16, driven by motor 18, draws air in through grille/light baffle 30 in inlet aperture 26, past ion brushes 36, through filter 14, coupled by shroud 18, and blows the treated air out through grille 32 in outlet aperture 28.

FIG. 1C shows a side view of air cleaner unit 10, looking in through inlet aperture 26. Grille/light baffle 30 has been removed in this view. Ultraviolet lamp 22 can be seen mounted on one side of housing 34, illuminating sanitizing filter 14. Ion brushes 36 can also be seen extending vertically in front of filter 14. The outline of fan 16 and shroud 18, which is behind filter 14 in this view, can be seen in broken lines.

The mechanical filter media of sanitizing filter 14 is composed of an electrically non-conductive material, preferrably polypropylene fibers. Ion brushes 36 are connected to one terminal, preferrably the negative terminal, of a high voltage source (not shown) to form an ionization unit. Alternatively, a corona tip or corona wire could be used in the ionization unit in place of the ion brushes 36 shown in FIG. 1.

Particulate pollutants become polarized as the airflow through the air cleaner unit 10 draws them past ion brushes 36. Free electrons on the surface of the particles are drawn to the side of the particle closer to or farther from the ion brushes, respectively, depending on whether the ion brushes are positively or negatively charged. When these polarized particles are trapped in the mechanical filter media of sanitizing filter 14, they polarize the surface molecules of the filter fibers. Subsequent polarized particles that are drawn through the mechanical filter media are electrically attracted to the polarized filter fibers, improving the filtration efficiency of filter 14.

This polarizing technique allows a less dense mechanical filter media to be used than would be needed in a filter unit that does not use the technique, while still meeting the HEPA filtration standard. The use of a less dense filter media makes it easier to draw air through the filter. Therefor, a lower fan speed can be used to filter a specified volume of air in a specified period of time than would be required with a denser filter. As a result of this lower fan speed, air cleaner unit 10 can can achieve HEPA standard filtration while operating more quietly than a unit not using this polarizing technique. Additionally, operating at a lower fan speed enables air cleaner unit 10 to draw less electrical power than a unit with a fan operating at higher speed.

It should be understood that use of this polarizing technique is not essential to the present invention. Other mechanical filtration media, as described hereinbelow, may be used without departing from the techniques of the present invention. Furthermore, the ionization unit may be omitted from the air cleaner unit while still remaining within the scope of the present invention.

While this embodiment of the invention utilizes a single inlet aperture 26 and a single outlet aperture 28, it should be understood that multiple apertures can be used for air inflow or outflow without departing from the techniques of the present invention. Similarly, while grille 30 is described in this embodiment of the invention as also serving as a light baffle, it should be understood that it is within the scope of the invention to use a serpentine air passage or other light blocking technique between inlet aperture 26 and UV lamp 22 to prevent UV radiation 24 from escaping housing 34.

An embodiment of sanitizing filter 14 of FIG. 1 is illustrated in cross-section in FIG. 2. Mechanical filter media 40 is typically a fibrous material in a non-woven sheet, however woven fibrous material, sintered metal or plastic particles, or other filter materials may also be used. Preferrably, mechanical filter media 40 meets the HEPA standard for particulate filtration. Photocatalytic filter 42, made in this embodiment from a wire mesh coated with TiO₂, is sandwiched next to mechanical filter media 40 by frame 44.

It should be understood that other photocatalysts, such as compounds of TiO₂, may be used within the scope of the present invention. Other techniques for supporting the photocatalyst in the airstream may also be used without departing from the techniques of the present invention, such as coating a substrate other than a wire mesh or coating the mechanical filtration medium directly. Further, either the mechanical filtration medium or a separate substrate could be fabricated with a photocatalyst embedded in its surface.

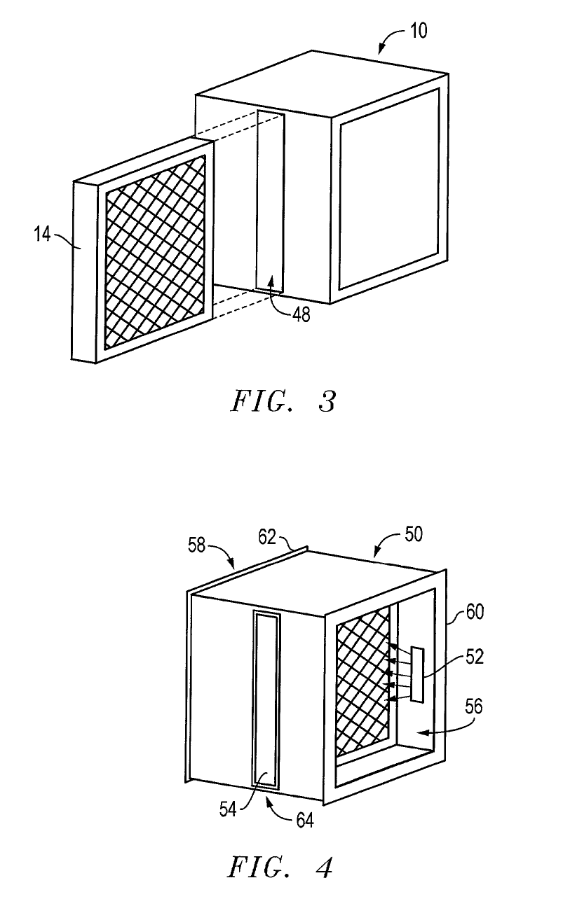

FIG. 3 illustrates freestanding air cleaner unit 10, which is portable and suitable for placement in a room or other enclosed space where air filtration and purification are desired. As shown, sanitizing filter 14 is inserted through filter replacement aperture 48 into its operative position within air cleaner unit 10. A door or cover plate (not shown in FIG. 3) is then closed to cover aperture 48 and to seal the unit so that air flows in through inlet aperture 26, rather than through filter replacement aperture 48. As killed organisms and oxidation byproducts gradually accumulate to coat the photocatalytic filter within sanitizing filter 14, they reduce both the efficiency of the filter and the sanitizing functionality of air cleaner unit 10. Filter efficiency and filter unit functionality can be restored by removing the used filter and inserting a new one with a clean, efficient photocatalytic filter.

Replacement of sanitizing filter 14 preferrably occurs at least every six months to maintain an appropriate level of sanitizing functionality. Ultraviolet lamp 22 is preferrably cleaned with a brush or dry cloth at least every 3 months to remove dust and debris that reduce the amount of UV radiation falling upon the photocatalyst in sanitizing filter 14. Because the amount of UV radiation emitted by UV lamp 22 gradually declines over the lifetime of the lamp, the lamp is preferrably replaced after 9000 hours or one year of use

FIG. 4 illustrates air filter unit 50, an embodiment of the present invention intended to be mounted within the air handling equipment or ductwork of a ventilation system. Such a ventilation system might be found in a building or in a vehicle, such as a car, an airplane, or a ship. Ultraviolet lamp 52 is mounted inside the unit to illuminate sanitizing filter 54, which is shown installed in the unit through filter replacement aperture 64. As in FIG. 3, a door or other cover plate (not shown in FIG. 4) is used to seal aperture 64 while unit 50 is in operation. Inlet aperture 56 and outlet aperture 58 (not visible in FIG. 4) are not covered with decorative grilles in this embodiment. Flanges 60 and 62 are provided to bolt air filter unit 50 to the air handling equipment or ductwork of the ventilation system. Because air is moved though the system by ventilation system fans, unit 50 does not have an internal fan.

FIG. 5 shows an embodiment of the techniques of the present invention in vacuum cleaner 80. Fan 86, powered by motor 88, draws particle-laden air 82 from suction hose 96 into bag 102. While larger particles are removed from the air stream by bag 102, finer particles and dust remain. These are purified and further filtered by exhaust filter 84 embodying the techniques of the present invention. Exhaust filter 84 is inserted into position to cover outlet aperture 96 through the filter replacement aperture covered by door 100. Ultraviolet lamp 92 illuminates sanitizing filter 84 with UV radiation 94, activating the photocatalyst in filter 84.

Other techniques for securing exhaust filter 84 in place over outlet aperture 96 may be used. In one embodiment, filter 84 is fitted in a housing that screws into aperture 96. In another embodiment, filter 84 is fitted in a housing with molded features that mate with catch mechanisms mounted on the exterior of vacuum cleaner housing 104, the catches securing the filter against outlet aperture 96.

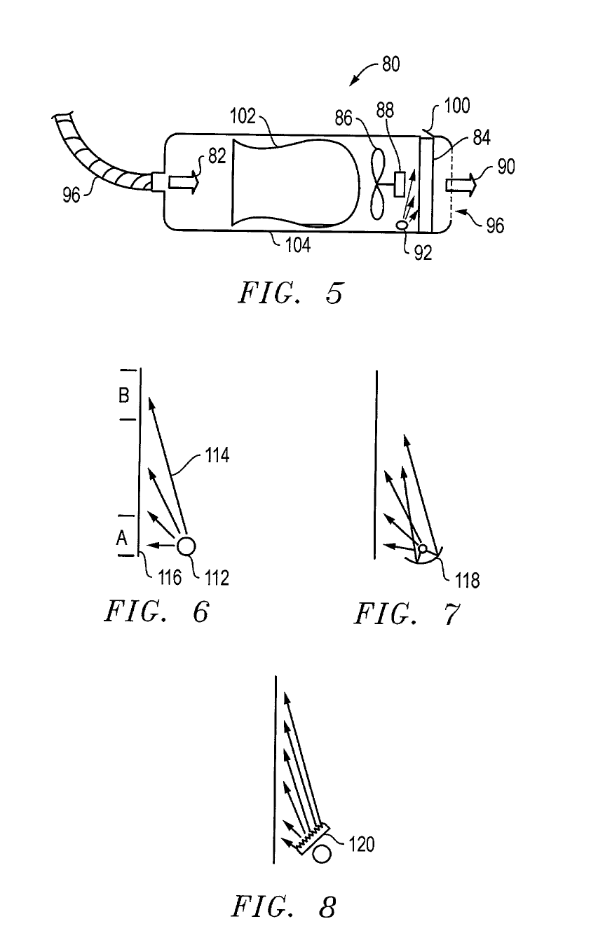

FIG. 6 depicts UV lamp 112 illuminating surface 116 of a sanitizing filter with UV radiation 114 as taught in the hereinbefore described embodiments of the present invention. While all of surface 116 is illuminated, region A of the surface receives more illumination than region B. If UV lamp 112 is too dim or too far away from region B, the photocatalyst in region B may not receive enough UV radiation to be activated. Thus, it may be desirable to utilize the techniques described below to provide a more even distribution of the UV radiation 114 from lamp 112 over surface 116.

A reflector 118 is employed to spread the light more evenly in FIG. 7. By reflecting the radiation from the side of lamp 112 that faces away from surface 116 toward region B, the illumination level in regions B can be increased. A compound lens 120 is shown in FIG. 8. A stepped lens with regions of different curvature can redirect light rays from lamp 112 that would have illuminated region A toward region B, to more evenly illuminate surface 116.

As such, an apparatus and method are described for a sanitizing air filter. In view of the above detailed description of the present invention and associated drawings, other modifications and variations will now become apparent to those skilled in the art. It should also be apparent that such other modifications and variations may be effected without departing from the spirit and scope of the present invention as set forth in the claims that follow.

What is claimed is:

1. A system for sanitizing and filtering air, comprising:
a chamber through which air passes;
an ultraviolet light source; and
a sanitizing filter removably mounted in the chamber, the filter comprising:
a mechanical filtration media; and
a photocatalytic agent;
wherein, when the sanitizing filter is mounted in the chamber, the ultraviolet light illuminates the photocatalytic agent and the air passing through the chamber is purified by the photocatalytic agent and filtered by the mechanical filtration media.

2. The system of claim 1, wherein the chamber is in a freestanding air cleaner.

3. The system of claim 1, wherein the chamber is in a ventilation system of a building.

4. The system of claim 1, wherein the chamber is in a ventilation system of a vehicle.

5. The system of claim 1, wherein the chamber is in a vacuum cleaner.

6. The system of claim 1, wherein the photocatalytic agent is on a substrate separate from the mechanical filtration media.

7. The system of claim 6, wherein the substrate is a mesh.

8. The system of claim 1, wherein the photocatalytic agent is titanium dioxide.

9. The system of claim 1, wherein the mechanical filtration media is electrically non-conductive and the system further comprises an ionization unit mounted in the chamber through which air passes, the air passing the ionization unit before passing through the sanitizing filter, whereby particulate pollution in the air is polarized before being deposited in the mechanical filter medium and polarizing the surface of the mechanical filter medium.

10. The system of claim 1, wherein the mechanical filtration media meets the HEPA standard.

11. The system of claim 1, wherein the ultraviolet light source further comprises a means to distribute the ultraviolet light with substantially even intensity across the photocatalytic agent.

12. The system of claim 11, wherein the means to distribute comprises a compound reflector.

13. The system of claim 11, wherein the means to distribute comprises a compound lens.

14. A sanitizing air filter, for use in an air passage having a source of light containing ultraviolet light, the sanitizing air filter comprising:
a mechanical filtration media; and
a photocatalytic agent;
wherein the sanitizing air filter is removably mounted in the air passage such that the ultraviolet light illuminates the photocatalytic agent.

15. The sanitizing air filter of claim 14, wherein the air passage is in a freestanding air cleaner.

16. The sanitizing air filter of claim 14, wherein the air passage is in a ventilation system of a building.

17. The sanitizing air filter of claim 14, wherein the air passage is in a ventilation system of a vehicle.

18. The sanitizing air filter of claim 14, wherein the air passage is in a vacuum cleaner.

19. The sanitizing air filter of claim 14, wherein the air passage further contains an ionization unit, ionozing the air before it passes over the sanitizing air filter and polarizing particles in the air, and wherein the mechanical filtration media is electrically non-conductive, whereby polarized particles trapped in the media polarize the media, and other polarized particles are electrically attracted to the polarized media.

20. The sanitizing air filter of claim 14, wherein the photocatalytic agent is on a substrate separate from the mechanical filtration media.

21. The sanitizing air filter of claim 20, wherein the substrate is a mesh.

22. The sanitizing air filter of claim 14, wherein the photocatalytic agent is titanium dioxide.

23. The sanitizing air filter of claim 14, wherein the mechanical filtration media meets the HEPA standard.

24. A method of sanitizing and filtering air, comprising the steps of:
inserting a sanitizing air filter in a chamber through which air passes, wherein the filter contains a mechanical filtration media and a photocatalytic agent;
illuminating the photocatalytic agent with ultraviolet light; and
renewing the photocatalytic agent by removing the sanitizing air filter and inserting a new sanitizing air filter;
wherein the air is sterilized by passing over the photocatalytic agent and filtered by passing through the mechanical filtration media.

25. The method of claim 24, wherein the step of illuminating comprises illuminating the photocatalytic agent with substantially equal intensity at all points on the sanitizing air filter.

26. The method of claim 24, wherein the mechanical filtration media is electrically non-conductive, the method further comprising the step of ionizing the air before it passes through the sanitizing air filter.

27. The method of claim 24, wherein the mechanical filtration media is electrically non-conductive, the method further comprising the steps of:
creating ions in the air before it passes through the sanitizing air filter, whereby particles in the air are polarized by the ions in the air;
trapping the polarized particles in the mechanical filtration media, whereby the polarization of the particles is transferred to the surface molecules of the mechanical filtration media;
whereby the polarized particles in the air are attracted electrostatically to the mechanical filtration media, improving its filtration efficiency.

28. The method of claim 24, wherein the chamber is in a freestanding air cleaner.

29. The method of claim 24, wherein the chamber is in a ventilation system of a building.

30. The method of claim 24, wherein the chamber is in a ventilation system of a vehicle.

31. The method of claim 24, wherein the chamber is in a vacuum cleaner.

32. The method of claim 24, wherein the photocatalytic agent is on a substrate separate from the mechanical filtration media.

33. The method of claim 32, wherein the substrate is a mesh.

34. The method of claim 24, wherein the photocatalytic agent is titanium dioxide.

35. The method of claim 24, wherein the mechanical filtration media meets the HEPA standard.
